(19) United States
(12) Patent Application Publication
(10) Pub. No.: US 2018/0371616 A1
(43) Pub. Date: Dec. 27, 2018

(54) METHOD OF FORMING AN ALUMINOSILICATE-ZEOLITE LAYER ON AN ALUMINIUM-CONTAINING METALLIC SUBSTRATE AND USE OF THE SUBSTRATE OBTAINED THEREBY

(71) Applicant: FAHRENHEIT GMBH, Halle/Saale (DE)

(72) Inventors: Ralph Herrmann, Halle/Saale (DE); Wilhelm Schwieger, Spardorf (DE); Rajesh Kumar Chandra, Nürnberg (DE)

(21) Appl. No.: 16/063,420

(22) PCT Filed: Dec. 6, 2016
(86) PCT No.: PCT/EP2016/079905

§ 371 Date: Jun. 18, 2018

(30) Foreign Application Priority Data
Dec. 18, 2015 (DE) 10 2015 122 301.5

(51) Int. Cl. C23C 18/12; C23C 22/66; B01J 29/08; B01J 29/18; B01J 29/70; B01J 20/16

(52) U.S. Cl. CPC C23C 18/1212; C23C 18/1241; C23C 22/66; B01J 29/08; C01B 39/04; B01J 29/7003; B01J 29/7015; B01J 20/165; B01J 29/18

(57) ABSTRACT

The invention relates to a method of forming an aluminosilicate zeolite layer on an aluminium-containing metallic substrate composed of metallic aluminium or an aluminium alloy which is introduced into an alkalized aqueous reaction dispersion in which silicon and optionally aluminium are present as network-forming elements, where, irrespective of whether or not aluminium is present in the aqueous reaction dispersion, the molar ratio between the aluminium in the aqueous reaction dispersion and the sum total of the network-forming elements present in the aqueous reaction dispersion is below 0.5, where, when aluminium is not present in the aqueous reaction solution, the deficiency molar ratio is 0, and the alkalized aqueous reaction dispersion containing the aluminium-containing metallic substrate is heated and aluminium is removed from the aluminium-containing metallic substrate for the aluminosilicate zeolite formation process and the layer of an aluminosilicate zeolite is formed on the aluminium-containing metallic substrate by in situ crystallizative application. In the course of this, an aluminium complexing agent with anchoring oxygen atoms is incorporated into the alkalized aqueous reaction dispersion. The invention further relates to the advantageous use of the method product in sorption-based fields of application.

The present invention relates to a method of forming an aluminosilicate-zeolite layer on an aluminium-containing metallic substrate of metallic aluminium or an aluminium alloy, which is transferred into an aqueous reaction dispersion, in which silicon and optionally aluminium are contained as network-forming elements, wherein the molar ratio between aluminium in the aqueous reaction dispersion to the total of the network-forming elements contained in the aqueous reaction dispersion is below 0.5, the aqueous reaction dispersion containing the aluminium-containing metallic substrate is heated, aluminium is removed from the aluminium-containing metallic substrate for the aluminosilicate-zeolite formation process and the layer of an aluminosilicate-zeolite is formed on the metallic substrate by in situ crystallization. The invention further relates to the use of the substrate obtained in this manner in sorption-based fields of application.

In a relatively narrow mineralogical sense, zeolites are silicate minerals and, in particular, aluminosilicates of complex chemical structure, which are characterised by the formation of porous tetrahedron networks (T networks). In accordance with the more general definition of the IZA (International Zeolites Association) zeolites are understood to be those materials which have T networks with a network density of <19 T atoms per 1000 Å³. They exhibit a structure with internal cavities, which can be of molecular size. This produces the property of zeolites of being able to absorb foreign atoms and foreign molecules into their porous structure. For instance, zeolites can store large amounts of water and release it again when heated. Zeolites are particularly suitable for heat transformation in contact with a heat exchanger. For this purpose, in accordance with an earlier state of the art, either beds of shaped zeolites are used or zeolites, which are introduced into open pored solid bodies, which are in thermal contact with a heat exchanger. Such a state of the art is disclosed, for instance, in DE 101 59 652 C2.

Zeolites are further used in the chemical industry for a multiplicity of further applications. These are e.g. ion exchange processes, whereby mostly synthetically produced zeolites are used in powder form with a crystal size of a few micrometres. Furthermore, zeolites are used as molecular sieves, whereby the zeolites can be introduced in the form of a loose filling of crystals or shaped materials into a filter system.

US 2003/0091872 A1 describes a method of producing a zeolite layer on a metal, such as aluminium, nickel, steel or titanium. Classical aluminosilicate layers are formed hereon in an aqueous reaction dispersion with a pH value of neutral to 12. The reaction dispersion also contains aluminium. By directly growing the zeolites on the substrate (in situ crystallisation), the adhesion of the zeolite layer to the substrate is improved. The Si and Al sources in the solution supply the constituents of the aluminosilicate-zeolites to be formed on the substrate. In the case of an aluminium-containing metallic substrate, a few aluminium atoms from the substrate can also be incorporated into the aluminosilicate-zeolite network.

A very interesting proposal to form a layer of an aluminosilicate-zeolite on an aluminium-containing metallic substrate is disclosed in WO 2006/08421 A2. This state of the art goes beyond that which is described above; thus one works in this case with a significant deficiency of aluminium in the reaction dispersion. Furthermore, this necessarily also requires that, when forming the zeolite layer on the aluminium-containing substrate, phosphorous is contained as a network-forming element in the aqueous reaction dispersion, into which the aluminium-containing substrate is introduced. Aluminium phosphate-zeolites are thereby formed which can be supplied to advantageous applications.

The state of the art outlined above, which goes back to WO 2010/099919, is already satisfactory. The aluminosilicate-zeolite coated metallic substrate obtained by the known process technology is susceptible of numerous possible usages, preferably in sorption-based fields of application. This technology exhibits numerous advantages, which may be outlined as follows: 1. Thin, hydrophilic aluminosilicate-zeolite layers on aluminium-containing metallic substrates, whereby, in particular, Al-rich aluminosilicates are present, are available. These carry a high lattice charge and are therefore significantly more hydrophilic than zeolites low in Al. 2. Classical adsorption agents, such as FAU, are producible for the first time in the form of compact layers with a firm, direct bond to metallic aluminium (very good thermal conduction). 3. The known method is a single step synthesis, whereby no foreign zeolite layer is necessary as a bonding matrix. 4. Many of the aluminosilicate-zeolites to be considered are available without a template and thus without calcination. 5. A layer of an aluminium-rich aluminosilicate-zeolite is formed very firmly on a metallic Al carrier.

It has transpired that in individual cases optimizations could be pursued. In these individual cases, the following disadvantages, which are in no way pronounced, have arisen: low layer yield, undesirable, low solubility aluminium oxide hydrate (e.g. gibbsite) collects occasionally in the form of a disruptive deposit on the Al carrier (negative shielding of the surface). Sometimes an undesired local dissolution of the Al carrier occurs and thus necessitates a limitation of the synthesis field, (e.g. lower concentrations) to protect the Al carrier.

The invention therefore had the object to prevent the disadvantages occurring in the prior art described above.

The solution to the object set forth above is represented by the following subject matter of the invention. This relates to a method of forming an aluminosilicate-zeolite layer on an aluminium-containing metallic substrate of metallic aluminium or an aluminium alloy which is introduced into an alkalised aqueous reaction dispersion, in which silicon and optionally aluminium are contained as network-forming elements, wherein irrespective of whether aluminium is present in the aqueous reaction dispersion or not, the molar ratio between the aluminium in the aqueous reaction dispersion to the total of the network-forming elements contained in the aqueous reaction dispersion, the deficiency ratio, is below 0.5, particularly below 0.4, wherein, when aluminium is not present in the aqueous reaction solution, the deficiency molar ratio is 0, and the alkalised aqueous reaction dispersion containing the aluminium-containing metallic substrate is heated, aluminium is removed from the aluminium-containing metallic substrate for the aluminosilicate-zeolite formation process and the layer of an aluminosilicate-zeolite is formed by in situ crystallisation, particularly by an Si source in an amount sufficient to form the Si/Al ratio of 1 to less than 10 and, with a deficiency molar ratio of more than 0, an additional Al source, which satisfies the requirement of the molar deficiency in the aqueous reaction dispersion, being introduced into the alkalised aqueous reaction dispersion. This method is characterised in that an aluminium complexing agent with O anchor atoms is incorporated into the alkalised aqueous reaction dispersion.

It is of advantage if these aluminium complexing agents have no structure-controlling template action, like many amines and ammonium salts. It is convenient to select the reaction conditions so that the synthesis windows for the desired Al-containing zeolites are not exited. This applies especially for the content of alkali ions and the basic pH value which is to be set. It is noted that as a result of the additional introduction of zeolite crystallization nuclei the targeted production of zeolite layers on an aluminium-containing metallic carrier can be improved. These nuclei are conveniently applied for this purpose in the form of a porous coating in layer form to the aluminium-containing metallic carrier to be coated and thus also fulfil the function of a type of protective layer.

With regard to the essence of the invention: this resides in the use of aluminium complexing compounds, (chelate formers). Organic polyacids and their salts and similar chelate formers with O as the anchor atom in the complex are particularly suitable. Different chelate formers with coordination numbers of 2 to 8 (in brackets) are set forth hereinafter: oxalate (2), dimercaptosuccinic acid (2), acetyl acetone (2), tartrate (2) and citrate (3).

It is preferred in accordance with the invention that the mentioned aluminium complexing agent with O anchor atoms is an organic polyacid or a salt thereof, particularly in the form of a sodium and/or potassium salt.

Preferred ligands are organic diacids and triacids, particularly oxalic acid, malonic acid, succinic acid, glutaric acid, adipic acid, maleic acid, tartaric acid, malic acid, glutamic acid and/or citric acid, particularly in the form of the sodium and/or potassium salts. Acetyl acetone can also be stated here as an example.

The concentration of the complexing agents used in accordance with the invention in the aqueous reaction dispersion is preferably greater than 8.5. There should, in particular, be an excess of alkali hydroxide, which is not neutralised by the organic acid. The minimum amount of the complexing agent salt in relation to Na₂O could be indicated with 0.15 mol for the dianion and 0.1 mol for the trianion. This is a suitable guideline for the expert to proceed successfully in the conduct of the method in accordance with the invention whilst taking account of the further matters relevant to the invention.

Numerous advantages are associated with the use of the aluminium complexing agents of the type described above. These enable a higher variability of the ratio of aluminium surface area to be coated and the volume of the solution used and a broader synthesis field (e.g. higher educt concentrations). Even in low dosages they prevent the formation of undesired aluminium oxide hydrates of low solubility (e.g. gibbsite), permit a better control of the dissolution of the metallic aluminium and thus an increased stability of the carrier. The controllable Al³⁺ content in the solution permits the targeted production of a larger number of zeolites. The organic complexing agents are to be removed from the product by washing or are decomposable at low temperatures as amines, whereby then no amines, acrylic compounds, (iso)cyanides or (iso)cyanates and nitrogen oxides are produced as when calcining the amines.

The reactions occurring in the context of the implementation of the present invention will be outlined below by way of example. The formation of precipitating Al oxide/hydroxide species which takes place without complexing under alkaline conditions can be prevented by the complexing without subsequent zeolite formation being disrupted. A higher Al³⁺ concentration, which reduces the dissolution of the metallic Al carrier by means of equilibrium displacement, thus develops and produces suitable conditions for the zeolite formation (Al³⁺ supersaturation). An exemplary reaction sequence with and without aluminium complexing agent is set forth below:

Aluminium Dissolution in Aqueous Solution without Complexing:

Al+3H₂O→Al³⁺+3OH-+3/2H₂→Al(OH)₃+3/2H₂

Method with Complexing:

Al³⁺+3Oxalate²⁻→[Al(Oxalate)₃]³⁻

Zeolite Formation in Alkaline Aqueous Solution:

[Al(Oxalate)₃]³⁻ₙ+mSi(OH)₄→3nOxalate²⁻+[(AlO₂)n(SiO₂)ₘ]ⁿ⁻[AlO₂)n(SiO₂)ₘ]ⁿ⁻=Zeolite

If, in the context of the present invention, a layer of an aluminium-rich aluminosilicate-zeolite is formed on an aluminium-containing metallic substrate, this is to be understood as far as possible. Only as an example though also preferred, the following aluminium-rich aluminosilicate-zeolites are to be produced: FAU (Zeolite X and Y), LTA, CHA, MOR and GIS. These preferred aluminium-rich aluminosilicate-zeolites fulfil the further preferred requirement in accordance with the invention that the Si/Al ratio therein is 1 to 10, particularly less than 6. It is preferred that this ratio is smaller than 4, particularly smaller than 3.5. The Si/Al ratio can have a value down to 1 but can basically not fall below this. These zeolites are characterised by a water sorption capacity at 25° C. of at least 12% or more with respect to the pure mass of zeolite and by IU-PAC Type I equilibrium isotherms for water vapour (see Sing et al, Pure Appl. Chem. 57 (1985) p. 603) and in accordance with Rodrizez-Reinoso et al (see Rodrizez-Reinsoso et al Studies in Surface Science and Catalysis 62 (1991) p. 685-692) are to be assigned to the hydrophilic “Group 1” adsorbents. A higher content of aluminium leads in general to a stronger adhesion of the formed zeolite layer to the aluminium-containing substrate.

It is also the object of the invention, as indicated, to form a layer of an aluminium-rich aluminosilicate-zeolite with the indicated specifications on an aluminium-containing metallic substrate. Here also, this is subject to no relevant limitations. It can in principle be a substrate of metallic aluminium. Other elements can be incorporated to form an alloy. Typical aluminium alloys are, for instance, AlFe 1.5 Mn 0.5 or AlMg3. Special alloy components can in principle be incorporated having regard to an advantageous effect for the application in question, such as silicon.

It is of particular importance that either the aluminium is not present in the aqueous reaction dispersion, whereby the deficiency molar ratio is then 0, or only in such amounts that the corresponding value is at least below 0.5 and in particular below 0.4. Since the deficiency relates to the Si/Al ratio present in the produced zeolite and this ratio can vary, particularly for aluminium-rich aluminosilicate-zeolites, from 1 to 10, a stepped indication of the deficiency quotient Al/(Al+Si) is sensible. Corresponding information is to be found in Table 1 following the description, from which a connection between the aluminium deficiency (Al/(Al+Si)) in the reaction dispersion and the zeolite composition (rounded numbers) is apparent. The Si/Al ratio of less than 6, particularly less than 4, is particularly preferred.

It has proved to be advantageous if the discussed molar ratio is below 0.05, particularly below 0.02. It can be particularly preferred if the deficiency molar ratio is 0 if the aqueous reaction dispersion does not directly contain an Al source. This deficiency requirement may be explained technologically as follows. In situ crystallization of the said layer takes place onto the aluminium-containing metallic substrate. Crystallization is an important reason why the product of the method exhibits the desirable properties, in particular a good adhesion of the formed zeolite layer to the surface of the aluminium-containing metallic substrate. If this deficiency is, for instance, 0, this means that the network-forming aluminium for forming the crystallized zeolite layer is only removed from the aluminium-containing metallic substrate. The elemental aluminium is thereby oxidised to Al³⁺ and equivalent hydrogen is formed in the aqueous reaction medium. The Al³⁺ is then primarily present with (OH)⁻ or complexed in accordance with the invention in the form of a counterion in the vicinity of the substrate surface and can further react there. This results in the particularly good anchoring between the surface of the aluminium-containing substrate and the formed aluminosilicate-zeolite. WO 2006/084211 A dealt with the discussed deficiency molar ratio in great detail, which was already discussed above and to which reference is made. These requirements are fulfilled to a surprisingly favourable extent by implementation of the core idea in accordance with the invention, in accordance with which an aluminium complexing agent with O anchor atoms is incorporated into the described alkalised aqueous reaction dispersion. This applies also to the aspects discussed below, which deal with advantageous embodiments of the invention.

It is of particular significance in the implementation of the teaching of the method in accordance with the invention in the selection of the necessary or preferred conditions to direct particular attention to the aluminium-containing substrate not being subjected to any disruptive dissolution in order to achieve the success which is sought in accordance with the invention. It is, in particular, important that after termination of the method the substrate still fulfils the requirements which are imposed by later usages. Thus it should still exhibit the necessary mechanical stability or the desired integrity in its shaping.

As indicated, the aqueous reaction dispersion which is used contains a Si source. There are no relevant limitations in this connection. This is preferably silica, silicates and/or silicic acid ester. In the event that for the practical performance of the method in accordance with the invention an Al source is present in the aqueous dispersion taking account of the discussed requirements, it is of advantage if it is an aluminium oxide hydrate, particularly pseudoboehmite and/or aluminium aluminate.

When performing the method in accordance with the invention, the existing aqueous reaction dispersion is alkalised because otherwise the layer of an aluminium-rich metallic aluminosilicate-zeolite is not produced. It is substantially open to the expert how he sets the pH value of the aqueous reaction dispersion to be alkaline. One can use, in particular, sodium hydroxide, potassium hydroxide, amines, basic Na salts and/or sodium aluminate. It is preferred that the pH value of the aqueous reaction dispersion is set to more than 9 and/or less than 13.8, particularly with Al alloys with a Al content of more than 90%.

It is advantageous in individual cases if colloidal sources of the silicon and/or the aluminium are used. In this connection it can be convenient to add fluoride salts or hydrofluoric acid to mineralise them, whereby it must be considered that the aqueous reaction dispersion must have a pH value of more than 7.

If can furthermore be advantageous if the aqueous reaction dispersion contains an organic template or an organic structure controlling agent and this can be, in particular, amines or ammonium salts or crown ethers. The function of such substances is known. They are referred to in the literature also, amongst other things, as a “Pattern molecule” and “Template molecule” (see Stephen G. Wilson, “Templating in Molecular Sieve Synthesis” (from Elsevier Science P.V.)).

It can be preferred in individual cases when carrying out the method in accordance with the invention to accelerate the crystal formation during the formation of the layer of the aluminium-rich aluminosilicate-zeolite. This is particularly advantageous if the reaction dispersion being used is highly aggressive to the aluminium-containing substrate. In this case, it is convenient, in order to produce a closed zeolite layer more rapidly, to add crystallization nuclei or an aged gel. An aged gel is a reaction dispersion, (is a reaction dispersion), which is capable of forming the respective target zeolite of the layer in powder form and after a number of hours at room temperature is already in the nucleus formation phase of the zeolite development without, however, reaching the zeolite growth phase. The high viscosity of the gel additionally permits the crystallisation nuclei to be applied directly to the aluminium-containing metallic substrate.

The method in accordance with the invention is preferably performed at increased temperature. It is convenient if the aqueous reaction dispersion and the aluminium-containing metallic substrate situated in it are heated to a temperature of 50 to 200° C., particularly of 70 to 130° C. In the event that the temperature of 100° C. is exceeded, it can be necessary to perform the reaction in a closed system, accordingly in an autoclave.

The inventors have recognised that it is particularly convenient for an advantageous performance of the method in accordance with the invention to direct attention to the ratio of the surface area of the aluminium-containing substrate to the volume of the aqueous reaction dispersion (in cm²/cm³). It proves to be preferred if this ratio is set to 0.03 to 20, particularly to 0.1 to 15 and particularly preferably to 1 to 8. If it is smaller than 0.1, particularly smaller than 0.03, then too much aqueous reaction dispersion is available, which can have a destructive effect on the aluminium-containing metallic substrate. It additionally appears that a too large volume sitting above the aluminium-containing substrate reduces the layer growth in favour of undesired crystal growth in the reaction dispersion. If the value of 15, particularly of 20, is exceeded, then there are not enough reaction partners available in the reaction solution for sufficient coverage of the aluminium-containing substrate with aluminosilicate-zeolite crystals.

The question could arise as to how strong is the zeolite layer formed in accordance with the invention on the aluminium-containing metallic substrate. The later usage of the product obtained is decisive for this. The invention has great flexibility in this connection.

When performing it, the layer thickness can be set to be as desired and can preferably be about 5 μm to 200 μm, particularly 5 μm to 100 μm. In order to form particularly thick coatings, it is convenient to continue the layer growth with fresh aqueous reaction dispersion.

After the crystallization of the aluminium-rich aluminosilicate-zeolite onto the aluminium-containing substrate, it is merely necessary to remove the coated substrate from the remaining reaction dispersion. Remaining reaction dispersion is conveniently removed from the coated substrate by washing. In the event that the method in accordance with the invention uses an organic, structure-controlling agent or an organic template, there is the possibility of further removing this agent or template, optionally after washing, by calcination.

The aluminosilicate-zeolite coated aluminium-containing metallic substrates obtained in accordance with the invention are susceptible of a variety of possible uses, preferably in sorption-based fields of applications, particularly for heterogeneous catalysis, in separation and cleaning processes, in sorption heat pumps, in conjunction with immobilised catalysts and in microreaction technology. This listing is not limiting.

In its practical implementation, the invention causes a variety of advantages to appear. Undesired foreign phases do not form, the partial reaction of the aluminium dissolution is strongly reduced and easily controllable. An advantageous zeolite is formed as a layer on the metallic carrier. A particular advantage is to be seen in the fact that nearly all technically relevant zeolites are made accessible. The formation of gibbsite, which was discussed, is strongly suppressed. By and large, all optimisation goals, which were discussed above with regard to the optimisation of the teaching of WO 2010/099919 A2, are achieved.

The invention, in accordance with which special aluminium complexing agents with O anchor atoms are used, proves to be particularly advantageous in comparison to complexing agents with N anchor atoms, as follows: aluminium ions do form complexes with ligands with N as the anchor atom (amines, ammonium salts), but these react further in a subsequent reaction to form an inert aluminium oxide hydrate (gibbsite). This immediately precipitates out and is thus not available as an aluminium source for the desired zeolite formation. On the other hand, complexing agents with O as the anchor atoms (particularly organic polyacids and their salts), form complexes, which then react further to form reactive Al oxide hydrate (pseuboehmite), the common aluminium source in classical zeolite syntheses, which is a significant advantage of the present invention. In this case, suitable aluminium species exist for a relatively long period of time for the zeolite formation. The suitable aluminium complexing in accordance with the invention additionally has a positive effect on the crystallization onto an aluminium-containing metallic substrate. Thus the reactive metal is dissolved less strongly, which otherwise is always critical at the high necessary pH values. The reason is possibly the increased presence of aluminium ions (as a complex) in the solution, whereby the dissolution equilibrium is displaced relatively strongly onto the side of the metallic aluminium.

The invention will be described in more detail below with reference to examples.

On the basis of the above description of the method in accordance with the invention, particularly taking account of the specific embodiments and the following explanatory examples, the expert is in the position with no difficulty to perform the invention successfully, whereby the following Table 1 can be significant.

TABLE 1
Examples of the dependence of the aluminium deficiency Al/(Al + Si) in the
reaction dispersion on the zeolite composition (data rounded)

| | Without | | | |
|---|---|---|---|---|
| | deficiency | Deficiency | | |
| | 100% of the | 80% of the | 10% of the | 0% of the |
| | theoretical Al | theoretical Al | theoretical Al | theoretical Al |
| Ratio of Si/Al | content | content | content | content |
| in the zeolite | Al/(Al + Si) | Al/(Al + Si) | Al/(Al + Si) | Al/(Al + Si) |
| 1.00 | 0.50 | 0.40 | 0.05 | 0 |
| 2.00 | 0.33 | 0.27 | 0.03 | 0 |
| 3.00 | 0.25 | 0.20 | 0.03 | 0 |
| 4.00 | 0.20 | 0.16 | 0.02 | 0 |
| 5.00 | 0.17 | 0.13 | 0.02 | 0 |

### EXAMPLE 1

A reaction mixture of composition 1.65 Na₂O:1.0 SiO₂:0.5 trisodium citronate:140 H₂O with sodium metasilicate as the silicon source is produced. For component solution 1, a 25% NaOH solution with the required citric acid and half of the water is stirred into it at 600 rpm for 1 h. For component solution 2, the silicon source (98%) is stirred with the remainder of the water, also at 600 rpm for 1 h. Component solution 2 is then added to component solution 1 and the mixture stirred at 800 rpm for 2 h.

120 ml PTFE containers were used for the synthesis. Aluminium specimens (with nucleation crystals) are placed in the containers and covered with the reaction solution. The containers are then closed and placed in a preheated oven for 36 h at 95° C.

After the synthesis, the containers are cooled with water (5-10 min). The coated aluminium specimens are removed and thoroughly washed with water. The specimens are then dried at 75° C.

Analysis: Zeolite X in the layer formed on the aluminium specimens.

### EXAMPLE 2

A reaction mixture of composition 0.9 Na₂O:1.0 SiO₂:0.5 disodium tartrates:140 H₂O was produced with sodium metasilicate as the silicon source in a manner corresponding to Example 1.

120 ml PTFE containers were used for the synthesis. Aluminium specimens (with or without nucleation crystals) are placed in the containers and covered with the reaction solution. The containers are then closed and placed in a preheated oven at 70° C. for 70 h.

After the synthesis, the containers are cooled with water (5-10 min). The coated aluminium specimens are removed and thoroughly washed with water. The specimens are then dried at 75° C.

Analysis: Zeolite Y in the layer formed on the aluminium specimens.

The following figures are to provide a contribution to further understanding of the present invention.

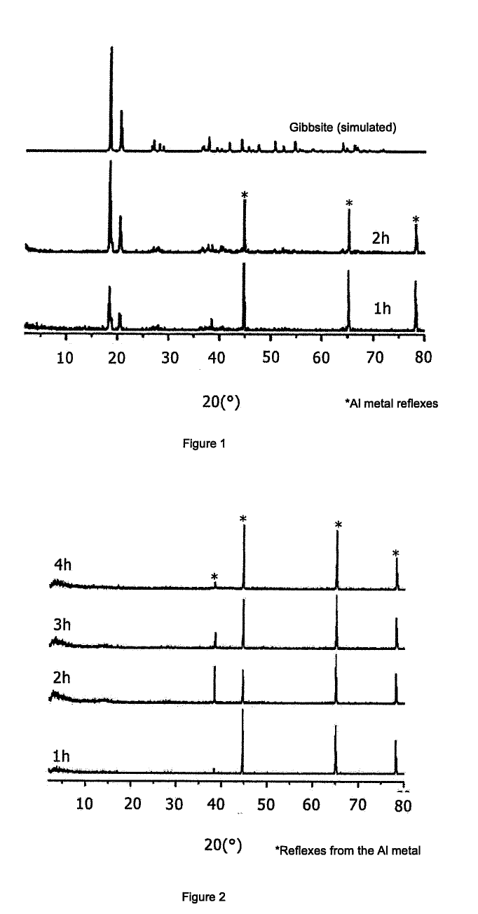

FIG. 1: shows dissolution of aluminium in the NaOH solution without additives at pH 12.5 with the formation of disadvantageous gibbsite

FIG. 2: shows aluminium dissolution in the NaOH solution with Na tartrate (complexing agent in accordance with the invention) at pH 12.5. No formation of gibbsite is indicated

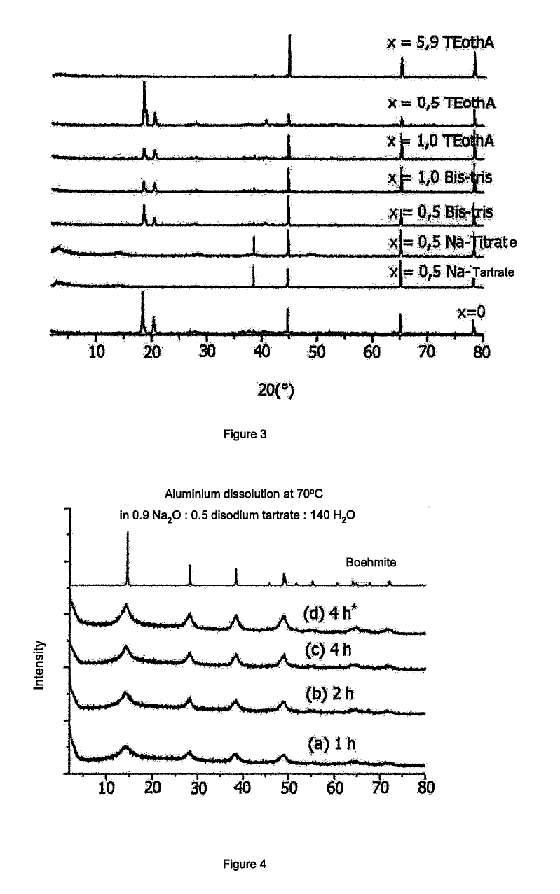

FIG. 3: XRD measurement (x-ray powder diffractometry) on sediment from the reaction of metallic aluminium in 0.9 Na₂O:140 H₂O:x complexing agent (TEothA=triethanolamine, bis-tris=bis-(2-hydroxy-ethyl)-amino-tris(hydroxymethyl)-methane. It may be clearly be seen in FIG. 3 that without complexing agents or with a lower concentration of amine complexing agents undesired gibbsite is produced. With polyacid complexes or a significant excess of triethanolamine pseudoboehmite is produced, which is a common Al source in zeolite synthesis.

FIG. 4: this relates to XRD measurements on the products of the dissolution of metallic aluminium in alkaline solution at low tartrate concentration. Only pseudoboehmite is formed. The solution corresponds to a zeolite synthesis solution in accordance with the invention but without the required Si source (0.9 Na₂O:0.5 disodium tartrate:140 H₂O)

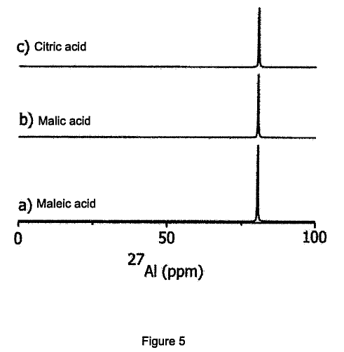

FIG. 5: this shows Al NMR spectra of the Al complexes of polyacids a) maleic acid, b) malic acid and c) citric acid.

1. A method of forming an aluminosilicate-zeolite layer on an aluminium-containing metallic substrate of metallic aluminium or an aluminium alloy, which is introduced into an alkalised aqueous reaction dispersion, in which silicon and optionally aluminium are contained as network-forming elements, whereby irrespective of whether aluminium is present in the aqueous reaction dispersion or not, the molar ratio between the aluminium in the reaction dispersion to the total of the network-forming elements contained in the aqueous reaction dispersion is below 0.5, whereby, when aluminium is not present in the aqueous reaction solution, the deficiency molar ratio is 0 and the alkalised aqueous reaction containing the aluminium-containing metallic substrate is heated and aluminium is removed from the aluminium-containing metallic substrate for the aluminosilicate-zeolite formation process and the layer of an aluminosilicate-zeolite is formed on the aluminium-containing metallic substrate by in situ crystallization, characterised in that an aluminium complexing agent with O anchor atoms is incorporated in the alkalised aqueous reaction dispersion.

2. A method as claimed in claim 1, characterised in that the aluminium complexing agent with O anchor atoms constitutes an organic polyacid or its salt in the form of a sodium and/or potassium salt.

3. A method as claimed in claim 2, characterised in that citric acid, tartaric acid, oxalic acid, malonic acid, malic acid and/or maleic acid is used as the organic polyacid or a salt thereof.

4. A method as claimed in claim 1, characterised in an aluminosilicate-zeolite layer is formed on a component, which includes an aluminium-containing metallic layer of aluminium or an aluminium alloy, which has a thickness of more than 0.05 mm.

5. A method as claimed in claim 1, characterised in that, as an additional Al source as well as the aluminium-containing substrate aluminium oxide hydrates, particularly pseudoboehmite and/or sodium aluminate, are used as well as the aluminium contained in the substrate.

6. A method as claimed in claim 1, characterised in that silica, silicates and/or silicic acid esters are used as an Si source.

7. A method as claimed in claim 1, characterised in that potassium hydroxide, basic Na or K salts and/or aluminates are used to produce alkaline conditions in the aqueous reaction dispersion.

8. A method as claimed in claim 1, characterised in that the pH value of the aqueous reaction dispersion is set to more than 9 and/or less than 13.8, when the Al alloy has an Al content of more than 90%.

9. A method as claimed in claim 1, characterised in that the ratio of the surface area of the aluminium-containing substrate to the volume of the aqueous reaction dispersion (in cm²/cm³) is set to between 1 and 8.

10. A method as claimed in claim 1, characterised in that those aluminium-rich aluminosilicate-zeolites are formed, in which the Si/Al ratio is less than 10.

11. A method as claimed in claim 1, characterised in that a layer of an aluminium-rich aluminosilicate-zeolite in the form of LTA, FAU, CHA, MOR or GIS is formed on the aluminium-containing substrate.

12. A method as claimed in claim 1, characterised in that the deficiency molar ratio is less than 0.05.

13. A method as claimed in claim 1, characterised in that the aqueous reaction dispersion contains an organic template or organic structure controlling agent, particularly in the form of amines or ammonium salts or crown ethers, is present.

14. A method as claimed in claim 1, characterised in that in the case of colloidal Si and/or Al sources, fluoride salts or hydrofluoric acid are added for their mineralisation.

15. A method as claimed in claim 1, characterised in that the aqueous reaction dispersion is heated to a temperature of 50 to 200° C.

16. A method as claimed in claim 1, characterised in that in order to accelerate the crystal formation in the formation of the aluminium-rich aluminosilicate-zeolite layer, crystal nuclei or an aged gel are added.

17. (canceled)

18. A method for heterogeneous catalysis in one of the following processes, separation and cleaning in sorption heat pumps, in conjunction with immobilised catalysts and in micro-reaction technology wherein the aluminosilicate-zeolite formed in claim 1 is employed.

19. A method as claimed in claim 1, characterised in an aluminosilicate-zeolite layer is formed on a component, which includes an aluminium-containing metallic layer of aluminium or an aluminium alloy, which has a thickness of more than 0.2 mm.

20. A method as claimed in claim 1, characterised in that those aluminium-rich aluminosilicate-zeolites are formed, in which the Si/Al ratio is less than 6.

21. A method as claimed in claim 1, characterised in that the deficiency molar ratio is less than 0.02.
